(19) United States
(12) Patent Application Publication
(10) Pub. No.: US 2024/0278259 A1
(43) Pub. Date: Aug. 22, 2024

(54) DUST COLLECTION UNIT FOR ELECTRIC PRECIPITATOR AND ELECTRIC PRECIPITATOR INCLUDING SAME

(71) Applicant: Hanon Systems, Daejeon (KR)

(72) Inventors: Ji-Yong Park, Daejeon (KR); Jae Ho Kim, Daejeon (KR); Su Jin Woo, Daejeon (KR)

(21) Appl. No.: 18/571,552

(22) PCT Filed: Oct. 17, 2022
(86) PCT No.: PCT/KR2022/015703

§ 371 Date: Dec. 18, 2023

(30) Foreign Application Priority Data
Nov. 9, 2021 (KR) 10-2021-0153066

(51) Int. Cl. B03C 3/82; B03C 3/12; B03C 3/47; B03C 3/66; F24F 8/192

(52) U.S. Cl. CPC B03C 3/82; B03C 3/12; B03C 3/47; B03C 3/66; F24F 8/194

(57) ABSTRACT

A dust collection unit for an electric precipitator and the electric precipitator including same, comprising: a plurality of dust collection films arranged apart from each other and including different, alternately arranged electrodes; a fixing member which is coupled to the plurality of dust collection films at one side or both sides where the plurality of collection films are arranged, so as to fix the plurality of dust collection films to be spaced apart from each other at specific intervals, and a ground electrode accommodated inside the fixing member. Accordingly, the dust collection performance of the electric precipitator may be improved by facilitating the discharge of a charging unit by suppressing an electric field generated by applying a high voltage to the plurality of dust collection films.

### CROSS REFERENCE TO RELATED APPLICATIONS

This patent application is a national phase under 35 U.S.C. § 371 of International Patent Application No. PCT/KR2022/015703 filed Oct. 17, 2022, which claims the benefit of priority from Korean Patent Application No. 10-2021-0153066 filed Nov. 9, 2021, each of which is hereby incorporated herein by reference in its entirety for all purposes.

### TECHNICAL FIELD

The present invention relates to a dust collection unit for an electric precipitator capable of adsorbing and filtering fine dust contained in the air in an air conditioning device such as an air conditioner or an air purifier, and the electric precipitator including the same.

### BACKGROUND ART

Generally, filters using non-woven fabrics made of fine fibers or the like are used to remove contaminants such as dust contained in air or gas. Since general fiber filters have limitations in reducing sizes of pores, the fiber filters may not filter dust particles having smaller sizes than the pores. In addition, when the sizes of the pores are excessively decreased, the air volume decreases and the pores are prematurely clogged by large dust particles, and thus there is a disadvantage in that the lifespan of the filter is very shortened. Therefore, an electric precipitator in which a decrease in air volume can be prevented, the problem in which the pores are clogged by large particles can be solved, and very small-sized impurity particles can be filtered is used.

As illustrated in FIGS. 1 and 2, an electric precipitator is configured so that a plurality of dust collection films 541 and 542 are disposed to be spaced apart from each other at certain intervals and a positive high voltage and a negative high voltage may be alternately applied to the dust collection films, and formed to remove fine particles from the air or gas passing between the dust collection films by adsorbing dust particles charged to have opposite polarities on surfaces of the dust collection films with a positive polarity or a negative polarity. In addition, a plurality of gap maintenance units 561 and 566 are coupled to the dust collection films in order to fix the dust collection films while constantly maintaining intervals between the plurality of dust collection films.

However, such a conventional electric precipitator has a problem in that an electric field generated by applying a high voltage interferes with the discharge of a charging unit for charging dust particles, thereby degrading the dust collection performance of the electric precipitator. In addition, as charged dust particles are accumulated on low-voltage side dust collection films, a potential at the low-voltage side gradually increases, thereby reducing a potential difference between the low-voltage side dust collection film and a high-voltage side dust collection film, and as a result, there is a problem in that the dust collection performance of the electric precipitator is degraded.

### DISCLOSURE

### Documents of Related Art

### Patent Document 1

KR 10-1839557 B1 (Mar. 12, 2018)

### Technical Problem

The present invention has been made in efforts to solve the problems and is directed to providing a dust collection unit for an electric precipitator in which the dust collection unit can suppress an electric field generated by applying a high voltage to dust collection films and facilitate the discharge of a charging unit, thereby improving the dust collection performance, and the electric precipitator including the same.

In addition, the present invention is also directed to providing a dust collection unit for an electric precipitator in which the dust collection performance can be secured even for a long time of use by extinguishing charges accumulated on low-voltage side dust collection films in which dust is collected and electromagnetic waves generated by applying a high voltage can be shielded, and the electric precipitator including the same.

### Technical Solution

A dust collection unit for an electric precipitator according to the present invention for achieving the objects includes a plurality of dust collection films arranged to be spaced apart from each other and having different electrodes alternately arranged thereon, a fixing member coupled to the plurality of dust collection films at one side or both sides at which the plurality of dust collection films are arranged and configured to fix the plurality of dust collection films to be spaced apart from each other at specific intervals, and a ground electrode stored inside the fixing member.

In addition, the ground electrode may be formed to extend in a direction in which the plurality of dust collection films are arranged and coupled to the fixing member to shield an electric field generated by applying a voltage to the plurality of dust collection films.

In addition, the plurality of dust collection films may include a plurality of first dust collection films connected to a low-voltage side power source and a plurality of second dust collection films connected to a high-voltage side power source, and the fixing member may include a first fixing member coupled to the plurality of first dust collection films and a second fixing member coupled to the plurality of second dust collection films.

In addition, the ground electrode may be coupled to any one or more of the first fixing member and the second fixing member.

In addition, the first fixing member may include a first support formed to extend in a direction in which the plurality of first dust collection films are arranged and a plurality of first spacers formed to protrude from the first support toward the first dust collection film, and the plurality of first dust collection films may be coupled by being inserted between adjacent first spacers. In addition, the first fixing member may include a 1-1 fixing member including a 1-1 support formed to extend in a direction in which the plurality of first dust collection films are arranged and a plurality of 1-1 spacers formed to protrude from the 1-1 support toward the first dust collection film, and a 1-2 fixing member including a 1-2 support formed to extend in the direction in which the plurality of first dust collection films are arranged and a plurality of 1-2 spacers formed to protrude from the 1-2 support toward the first dust collection film, an insertion groove may be formed in the 1-1 fixing member so that a ground electrode is inserted into the insertion groove, and a portion of the 1-2 fixing member is coupled by being inserted into the insertion groove, and the 1-1 spacer and the 1-2 spacer may be alternately disposed to be spaced apart from each other.

In addition, a plurality of coupling portions may be formed to extend to the first dust collection film side, and the first dust collection film may be coupled by being inserted between the plurality of coupling portions.

In addition, the 1-1 fixing member may further include a plurality of 1-1 protruding portions formed to protrude from the 1-1 support toward the first dust collection film, and the 1-2 fixing member may further include a plurality of 1-2 protruding portions formed to protrude from the 1-2 support toward the first dust collection film, the 1-1 protruding portion may be disposed at a position corresponding to the 1-2 spacer, the 1-2 protruding portion is disposed at a position corresponding to the 1-1 spacer, and the plurality of coupling portions may be interposed between the 1-1 spacer and the 1-2 protruding portion or between the 1-2 spacer and the 1-1 protruding portion.

In addition, portions of the plurality of coupling portions may protrude inward from surfaces in which the 1-1 spacer and the 1-2 protruding portion face each other and surfaces in which the 1-2 spacer and the 1-1 protruding portion face each other.

In addition, protrusions may be formed to protrude from opposite surfaces into which the first dust collection films are inserted of the plurality of spacers.

In addition, the dust collection unit may further include a case to which the plurality of dust collection films and the fixing member are fixedly coupled.

In addition, a ground terminal may be formed on the case, and one end of the ground electrode may be in contact with and electrically connected to the ground terminal.

In addition, the first fixing member may include an elastically fixing portion formed at one side thereof, the one end of the ground electrode may be positioned on the elastically fixing portion of the first fixing member so that the one end of the ground electrode is exposed to or protrudes from an outer surface of the elastically fixing portion, and a coupling hole and a coupling protrusion may be formed on the case so that the elastically fixing portion of the first fixing member is inserted into the coupling hole and a portion of the elastically fixing portion is fixedly caught on the coupling protrusion, and the one end of the ground electrode may be in close contact with a ground terminal.

In addition, an electric precipitator according to the present invention includes the dust collection unit for an electric precipitator, and a charging unit disposed to be spaced apart from a side adjacent to the ground electrode of the dust collection unit for an electric precipitator and configured to charge passing dust particles.

### Advantageous Effects

The dust collection unit for an electric precipitator according to the present invention has an advantage in that it is possible to improve the dust collection performance of the electric precipitator by suppressing the electric field generated by applying the high voltage to the dust collection films and facilitating the discharge of the charging unit.

In addition, there is an advantage in that it is possible to secure the performance of the electric precipitator even for a long time of use by extinguishing the charges accumulated on the low-voltage side dust collection film.

In addition, there is an advantage in that it is possible to shield the electromagnetic waves discharged to the outside of the electric precipitator.

### BRIEF DESCRIPTION OF THE DRAWINGS

FIG. 1 is an exploded perspective view illustrating a conventional electric precipitator.

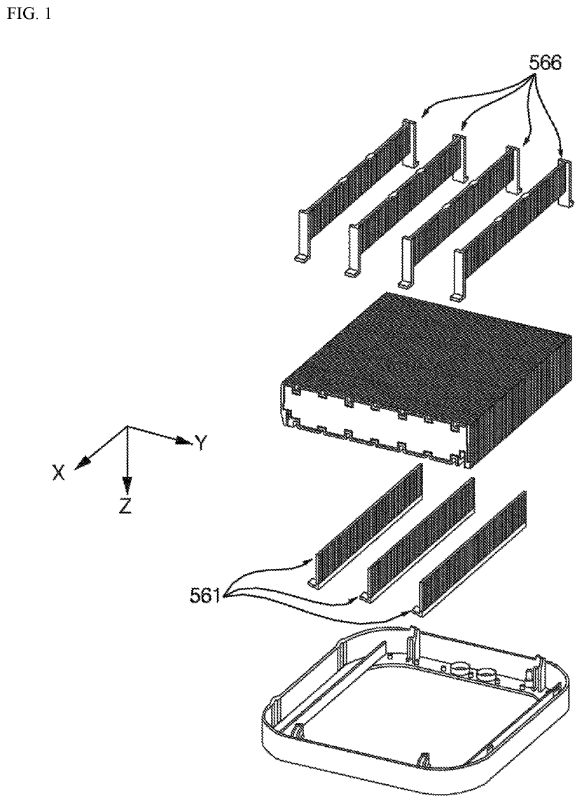

FIG. 2 is a perspective view illustrating a conventional electric precipitator.

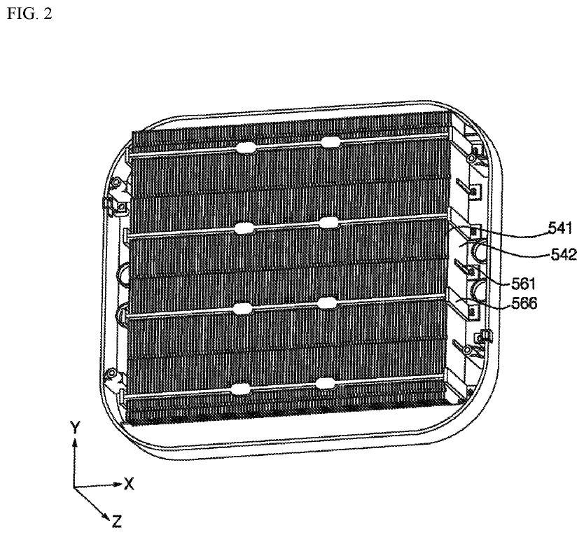

FIG. 3 an assembling perspective view illustrating a dust collection unit for an electric precipitator according to a first embodiment of the present invention.

FIG. 4 is an exploded perspective view illustrating a dust collection unit for an electric precipitator according to a first embodiment of the present invention.

FIG. 5 is a partial perspective view illustrating a portion of the dust collection unit for an electric precipitator according to the first embodiment of the present invention.

FIG. 6 is a partial perspective view illustrating a specific coupling structure of a first fixing member and a ground electrode of the dust collection unit for an electric precipitator according to the first embodiment of the present invention.

FIG. 7 is a partial front view illustrating a specific coupling structure of a first fixing member and a ground electrode of the dust collection unit for an electric precipitator according to the first embodiment of the present invention.

FIG. 8 is a partial perspective view illustrating a specific coupling structure of a first fixing member, a ground electrode, a first dust collection film, and a case of a dust collection unit for an electric precipitator according to a second embodiment of the present invention.

FIG. 9 is a partial front view illustrating a specific coupling structure of a first fixing member, a ground electrode, a first dust collection film, and a case of a dust collection unit for an electric precipitator according to a second embodiment of the present invention.

FIG. 10 is a partial perspective view illustrating a specific shape of the ground electrode and a coupling structure with the first fixing member of the dust collection unit for an electric precipitator according to the second embodiment of the present invention.

FIG. 11 is a partial front view illustrating a specific shape of the ground electrode and a coupling structure with the first fixing member of the dust collection unit for an electric precipitator according to the second embodiment of the present invention.

FIG. 12 is a conceptual diagram illustrating an electric precipitator including the dust collection unit for an electric precipitator according to the present invention and a charging unit.

FIG. 13 is a partial perspective view illustrating a portion of the electric precipitator.

### MODE FOR INVENTION

Hereinafter, a dust collection unit for an electric precipitator according to the present invention having the above configuration will be described in detail with reference to the accompanying drawings.

### Embodiment 1

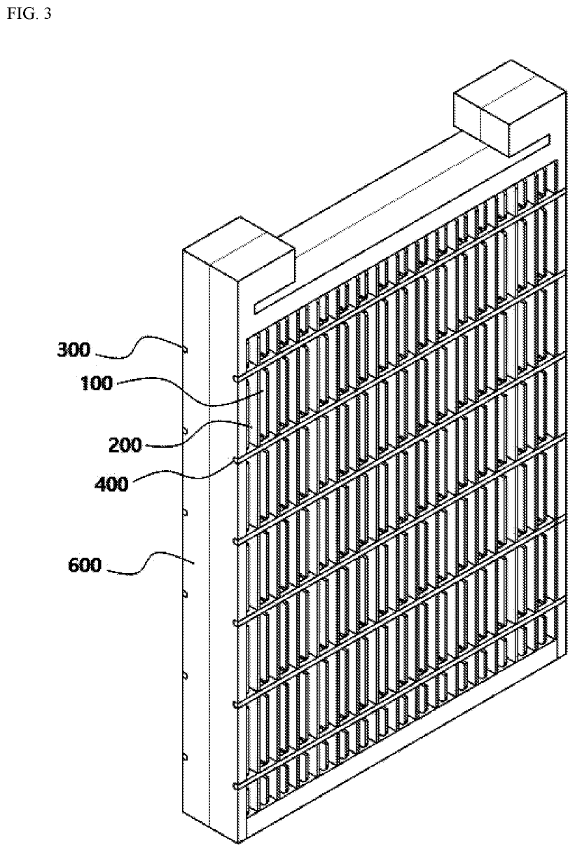

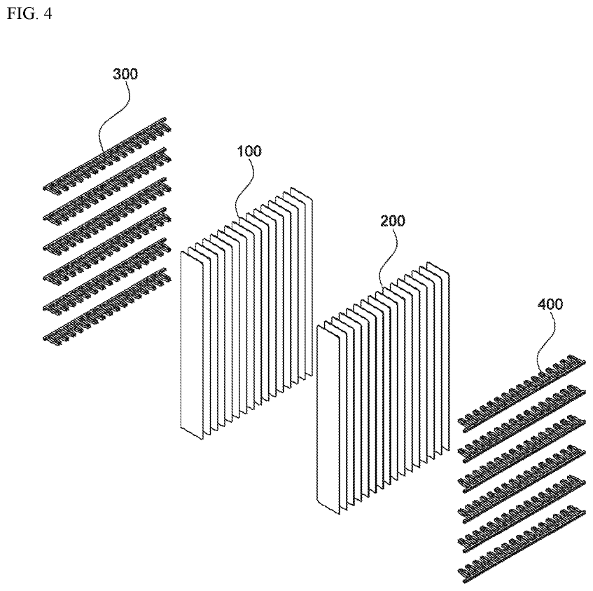

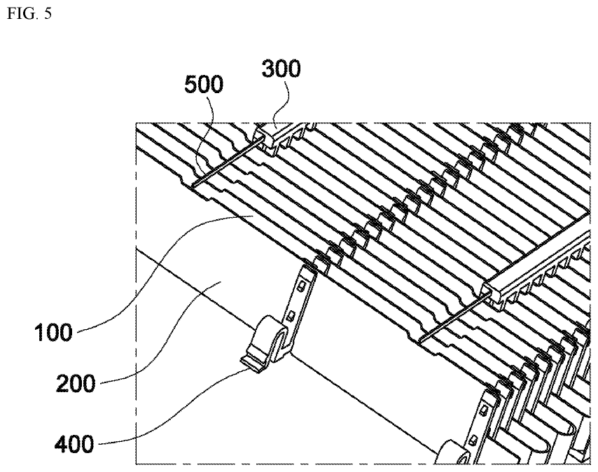

FIGS. 3 and 4 are an assembling perspective view and an exploded perspective view illustrating a dust collection unit for an electric precipitator according to a first embodiment of the present invention, and FIG. 5 is a partial perspective view illustrating a portion of a dust collection unit for an electric precipitator according to the first embodiment of the present invention. As illustrated, the dust collection unit for an electric precipitator according to the first embodiment of the present invention may largely include a plurality of first dust collection films 100, a second dust collection film 200, a first fixing member 300, a second fixing member 400, and a ground electrode 500 and may further include a case 600.

The first dust collection film 100 is formed as a plurality of first dust collection films, and the plurality of first dust collection films 100 may be arranged side by side to be spaced apart from each other at specific intervals. In addition, the plurality of first dust collection films 100 may be connected to a negative electrode power source, which is a low-voltage side, so that the negative electrode power source may be applied to the plurality of first dust collection films 100.

The second dust collection films 200 is formed as a plurality of second dust collection films, and the plurality of second dust collection films 200 may be arranged side by side to be spaced apart from each other at specific intervals. In addition, the plurality of second dust collection films 200 may be connected to a positive electrode power source, which is a high-voltage side, so that the positive electrode power source may be applied to the plurality of second dust collection films 200. In addition, the plurality of second dust collection films 200 may be inserted between the plurality of first dust collection films 100 and disposed to be spaced apart from the first dust collection films 100, and the dust collection films may be arranged in the form in which the first dust collection film 100 and the second dust collection film 200 are disposed alternately. Therefore, the dust collection films connected to different electrodes may be arranged alternately.

The first fixing member 300 may be coupled in the form of being fitted into outer sides of the plurality of first dust collection films 100, and the plurality of first dust collection films 100 may be connected and fixed by the first fixing member 300. In addition, the first fixing member 300 may include a first support 310 and a plurality of first spacers 320. The first support 310 may be formed in a long rod shape in a direction in which the plurality of first dust collection films 100 are arranged, and the plurality of first spacers 320 may be formed to extend from the first support 310 toward the plurality of first dust collection films 100. In addition, the plurality of first spacers 320 may be disposed to be spaced apart from each other at specific intervals in a direction in which the first support 310 is formed to extend. Here, in the plurality of first spacers 320, a pair of two first spacers 320 spaced apart from each other is formed to have an interval at which one first dust collection film 100 may be fixedly inserted, and a plurality of pairs of the first spacers 320 may be disposed to be spaced apart from each other. In addition, an interval between the pair of the first spacers 320 is formed to be larger than an interval between an adjacent pair of the first spacers 320, and thus the second dust collection film 200 may be inserted between the adjacent pair of the first spacers 320 and disposed to be spaced apart from the first spacer 320.

The second fixing member 400 may be coupled in the form of being fitted into outer sides of the plurality of second dust collection films 200, and the plurality of second dust collection films 200 may be fixedly connected by the second fixing member 400. In addition, the second fixing member 400 may be formed in a shape that is the same as or similar to the first fixing member 300. In addition, the first fixing member 300 and the second fixing member 400 may be coupled to the dust collection films at one side or both sides at which the plurality of first dust collection films 300 and the plurality of second dust collection films 200 are arranged.

The ground electrode 500 may be stored inside the first fixing member 300. The ground electrode 500 may be formed to extend in a direction in which the first support 310 of the first fixing member 300 is formed to extend, and the ground electrode 500 may be fixedly coupled to the first support 310 of the first fixing member 300. Therefore, the ground electrode 500 may be disposed outside a relatively large side (one surface side in a thickness direction) of a hexahedral-shaped structure in which the plurality of first dust collection films 100 and the plurality of second dust collection films 200 are formed by being arranged. In addition, the ground electrode 500 may be made of metal, which is an electrical conductor, or the like, and the ground electrode 500 may function to shield an electric field generated when a high voltage is applied to the first dust collection film 100 and the second dust collection film 200. In addition, although not illustrated, the ground electrode 500 may be fixedly coupled to the second fixing member 400, and the ground electrode 500 may be coupled to each of the first fixing member 300 and the second fixing member 400.

The case 600 may be made of a non-conductor such as plastic substantially in a quadrangular frame shape or an electrically insulating material, and the plurality of first dust collection films 100, the plurality of second dust collection films 200, the first fixing member 300, and the second fixing member 400 may be fixedly coupled to the case 600. In addition, a negative electrode lead connected to the plurality of first dust collection films 100 to apply the negative electrode power source may be formed on the case 600, and a positive electrode lead connected to the plurality of second dust collection films 200 to apply the positive electrode power source may be formed on the case 600.

Therefore, when one of high voltages with different polarities are applied to each of the first dust collection film 100 and the second dust collection film 200, an electric field may be generated between the first dust collection film 100 and the second dust collection film 200, and as air containing negatively ionized or positively ionized dust particles passes between the first dust collection film 100 and the second dust collection film 200, the dust particles may be collected by being adsorbed on a surface of the first dust collection film 100 or the second dust collection film 200 by the electric field.

Therefore, since the ground electrode coupled to the fixing member of the dust collection unit for an electric precipitator according to the present invention may shield the electric field generated by applying the voltage to the dust collection films, it is possible to facilitate the discharge of the charging unit disposed adjacent to the dust collection unit of the electric precipitator, thereby improving the dust collection performance of the electric precipitator. In addition, it is possible to shield electromagnetic waves discharged to the outside of the dust collection unit.

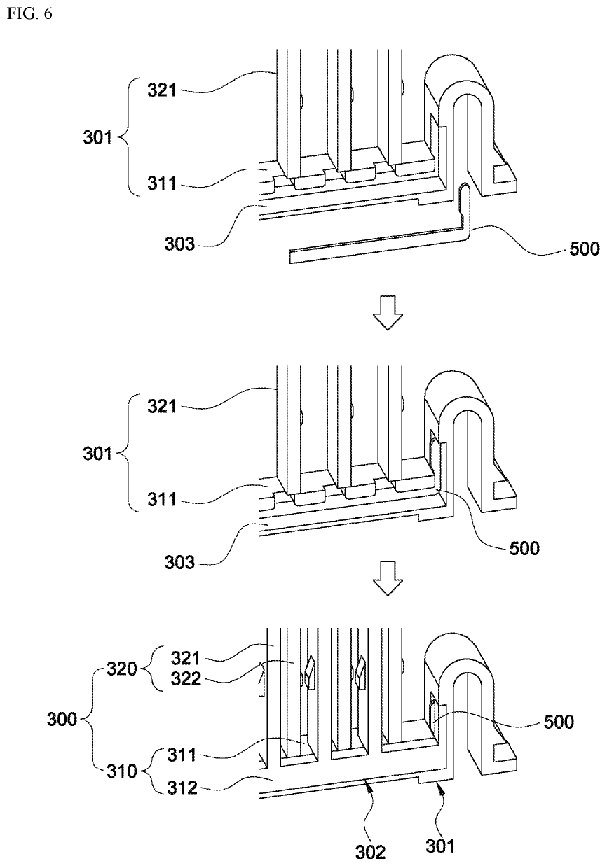

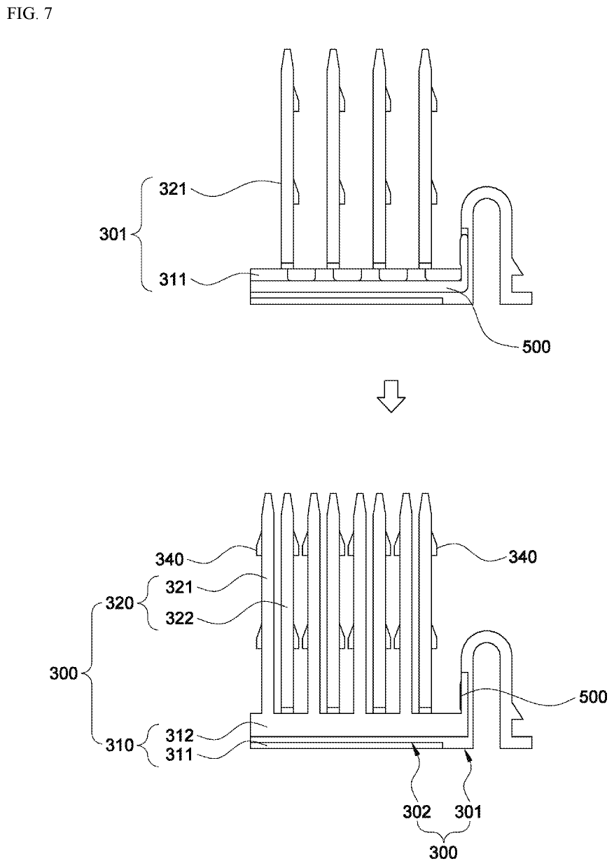

FIGS. 6 and 7 are a partial perspective view and a partial front view illustrating a specific coupling structure of a first fixing member and a ground electrode of the dust collection unit for an electric precipitator according to the first embodiment of the present invention.

As illustrated, the first fixing member 300 may include a 1-1 fixing member 301 and a 1-2 fixing member 302. In addition, the 1-1 fixing member 301 may include a 1-1 support 311 and a plurality of 1-1 spacers 321, and the 1-2 fixing member 302 may include a 1-2 support 312 and a plurality of 1-2 spacers 322. In other words, the first fixing member 300 may be formed as one first fixing member 300 by coupling two components, that is, the 1-1 fixing member 301 to the 1-2 fixing member 302.

The 1-1 support 311 of the 1-1 fixing member 301 may be formed to extend in a direction in which the plurality of first dust collection films 100 are arranged, and the plurality of 1-1 spacers 321 may be formed to protrude from the 1-1 support 311 toward the first dust collection film 100. In addition, the 1-2 support 312 of the 1-2 fixing member 302 may be formed to extend in the direction in which the plurality of first dust collection films 100 are arranged, and the plurality of 1-2 spacers 322 may be formed to protrude from the 1-2 support 312 toward the first dust collection film 100. In addition, an insertion groove 303 may be concavely formed in the 1-1 fixing member 301, the ground electrode 500 may be inserted into the insertion groove 303, and a portion or the overall portion of the 1-2 support 312 of the 1-2 fixing member 302 may be coupled by being inserted into the insertion groove 303. Here, one end of the ground electrode 500 may become a state in which a portion thereof protrudes and be exposed to the outside of the first fixing member 300. In addition, when the 1-1 fixing member 301 and the 1-2 fixing member 302 are coupled, the 1-1 spacer 321 and the 1-2 spacer 322 may be formed in the form that is alternately disposed to be spaced apart from each other. Therefore, the ground electrode 500 may be easily fixedly coupled to the first fixing member 300, and the plurality of first dust collection films 100 may be easily coupled to the first fixing member 300.

In addition, protrusions 340 may be formed on opposite surfaces into which the first dust collection films 100 are inserted of the plurality of first spacers 320. Therefore, the second dust collection film 200 to which the voltage with a different polarity from the first dust collection film 100 is applied may maintain a constant interval from the first dust collection film 100, thereby preventing a degradation in the dust collection performance of the electric precipitator.

### Embodiment 2

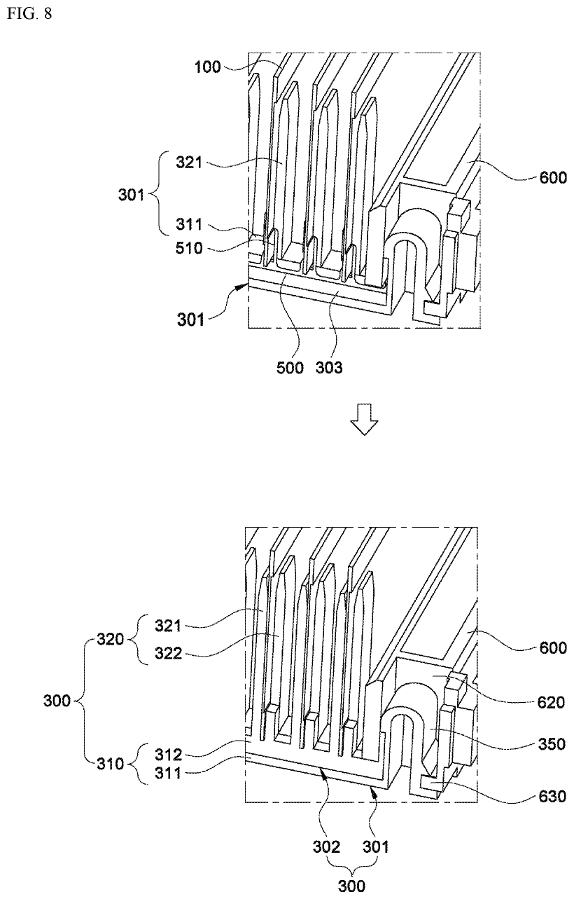

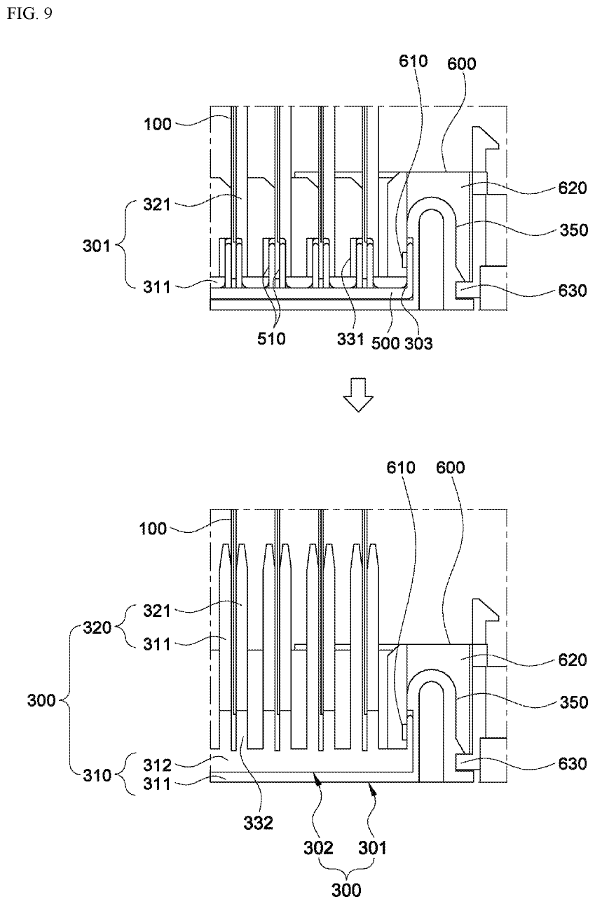

FIGS. 8 and 9 are a partial perspective view and a partial front view illustrating a specific coupling structure of a first fixing member, a ground electrode, a first dust collection film, and a case of a dust collection unit for an electric precipitator according to a second embodiment of the present invention.

As illustrated, the dust collection unit for an electric precipitator according to the second embodiment of the present invention may largely include the plurality of first dust collection films 100, the second dust collection film 200, the first fixing member 300, the second fixing member 400, and a ground electrode 500 and may further include a case 600.

The first dust collection film 100, the second dust collection film 200, the first fixing member 300, and the second fixing member 400 in the second embodiment may be formed in the same manner as those of the first embodiment. In addition, the ground electrode 500 may have a shape in which a plurality of coupling portions 510 are additionally formed to extend from the ground electrode 500 in the first embodiment. In other words, in the second embodiment, the ground electrode 500 may be formed to extend in the direction in which the first support 310 of the first fixing member 300 is formed to extend, and the ground electrode 500 may have a shape in which the plurality of coupling portions 510 protrude toward the first dust collection film 100. Here, the plurality of coupling portions 510 may be formed in the same number as the first spacers 320 at positions corresponding to the first spacers 320. Therefore, the first dust collection film 100 may be coupled by being inserted between a pair of the two coupling portions 510.

Therefore, by extinguishing the charges accumulated on the low-voltage side dust collection film by the ground electrode, it is possible to secure the dust collection performance of the electric precipitator even for a long time of use.

In addition, the 1-1 fixing member 301 in the second embodiment may have a configuration in which a plurality of 1-1 protruding portions 331 are additionally formed to protrude in the first embodiment, and the 1-2 fixing member 302 in the second embodiment may have a configuration in which a plurality of 1-2 protruding portions 332 are additionally formed to protrude in the first embodiment. In other words, the plurality of 1-1 protruding portions 331 may be formed on the 1-1 fixing member 301 from the 1-1 support 311 toward the first dust collection film 100. The plurality of 1-2 protruding portions 332 may be formed on the 1-2 fixing member 302 from the 1-2 support 312 toward the first dust collection film 100. In addition, the 1-1 protruding portion 331 may be disposed at a position corresponding to the 1-2 spacer 322, and the 1-2 protruding portion 332 may be disposed at a position corresponding to the 1-1 spacer 321. Therefore, the plurality of coupling portions 510 of the ground electrode 500 may be interposed between the 1-1 spacer 321 and the 1-2 protruding portion 332 or between the 1-2 spacer 322 and the 1-1 protruding portion 331. Here, a groove connected to the insertion groove 303 may be formed in the 1-1 spacer 321 so that the coupling portion 510 and the 1-2 protruding portion 332 may be coupled by being inserted into the groove. In addition, a groove that may be connected to the insertion groove 303 may be formed in the 1-2 spacer 322 so that the coupling portion 510 and the 1-1 protruding portion 331 may be coupled by being inserted into the groove. Therefore, the coupling portion 510 of the ground electrode 500 may not be exposed in the remaining directions excluding surfaces in which a pair of the 1-1 spacer 321 and 1-2 spacer 322 faces each other.

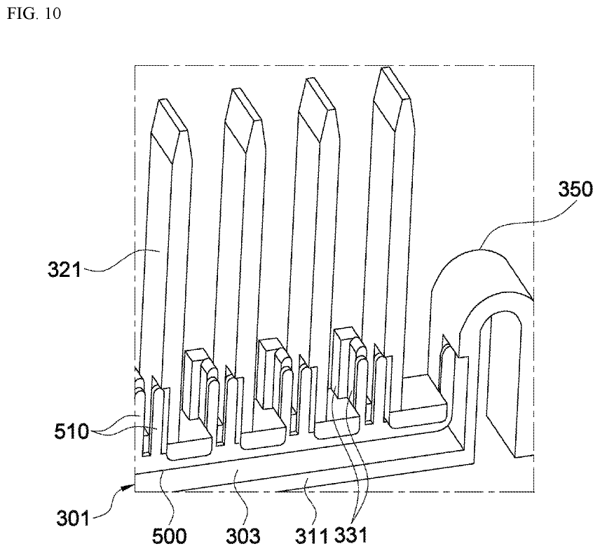

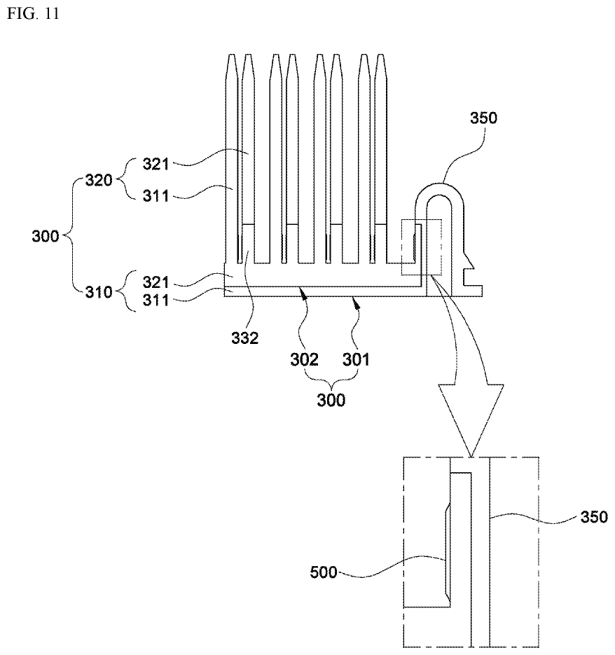

FIGS. 10 and 11 are a partial perspective view and a partial front view illustrating a specific shape of the ground electrode and a coupling structure with the first fixing member of the dust collection unit for an electric precipitator according to the second embodiment of the present invention.

As illustrated, portions of the plurality of coupling portions 510 may protrude inward from the surfaces in which the pair of the 1-1 spacer 321 and the 1-2 protruding portion 332 faces each other and surfaces in which a pair of the 1-2 spacer 322 and the 1-1 protruding portion 331 faces each other. Therefore, it is possible to easily maintain a state in which the first dust collection film 100 is inserted between and in contact with a pair of the two coupling portions 510.

In addition, although not illustrated, even in the second embodiment as in the first embodiment, protrusions may be formed on opposite surfaces into which the first dust collection films 100 are inserted of the plurality of first spacers 320.

Referring to FIGS. 9 to 11, a ground terminal 610 may be formed on the case 600, and one end of the ground electrode 500 may be in contact with and electrically connected to the ground terminal 610. Therefore, the charges accumulated on the first dust collection film 100 may move along the ground electrode 500 and be discharged to an external ground through the ground terminal 610.

In addition, the first fixing member 300 may include an elastically fixing portion 350 formed at one side thereof, one end of the ground electrode 500 may be positioned on the elastically fixing portion 350 of the first fixing member 300 so that the one end of the ground electrode 500 is exposed to or protrudes from an outer surface of the elastically fixing portion 350, a coupling hole 620 and a coupling protrusion 630 may be formed on the case 600 so that the elastically fixing portion 350 of the first fixing member 300 is inserted into the coupling hole 620 and a portion of the elastically fixing portion 350 is fixedly caught on the coupling protrusion 630, and the one end of the ground electrode 500 may be in close contact with the ground terminal 610.

Therefore, since the elastically fixing portion 350 of the first fixing member 300 may be coupled by being inserted into the coupling hole 620 of the case 600 and at the same time, the one end of the ground electrode 500 coupled to the first fixing member 300 is in close contact with the ground terminal 610 formed on the case 600, it is possible to facilitate the electrical connection between the ground electrode 500 and the ground terminal 610. In addition, the first fixing member 300 may be easily and fixedly coupled to and also be easily separated from the case 600. The coupling structure of the first fixing member 300 and the case 600, which includes the elastically fixing portion 350, the coupling hole 620, and the coupling protrusion 630, may be formed in various manners other than that illustrated. In addition, the coupling structure of the first fixing member 300 and the case 600, which excludes the ground electrode 500 and the ground terminal 610, may also be applied to a coupling structure between the second fixing member 400 and the case 600 in the same manner.

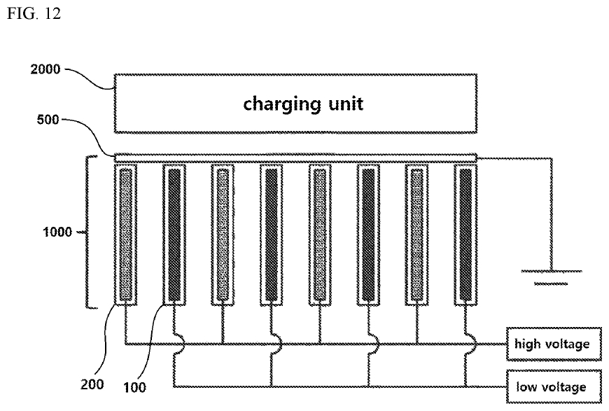

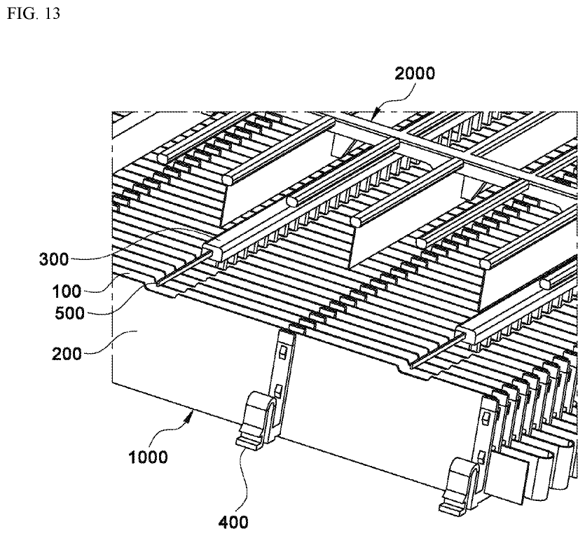

FIGS. 12 and 13 are a conceptual diagram illustrating an electric precipitator including the dust collection unit for an electric precipitator according to the present invention and a charging unit, and a partial perspective view illustrating a portion of the electric precipitator.

As illustrated, the electric precipitator according to the present invention may include a dust collection unit 1000, and a charging unit 2000 disposed to be spaced apart from a side adjacent to a ground electrode 500 of the dust collection unit 1000 and for charging passing dust particles. In other words, the electric precipitator according to the present invention may include the charging unit 2000 for charging the dust particles with a positive charge or a negative charge and the dust collection unit 1000 for collecting the charged dust particles using an electric field. Here, since the charging unit 2000 is disposed to be spaced apart from the dust collection unit 1000 with the ground electrode 500 interposed therebetween, the ground electrode 500 may shield an electric field generated by applying a high voltage to dust collection films of the dust collection unit 1000 to facilitate the discharge of the charging unit 2000, thereby improving the dust collection performance of the electric precipitator. In addition, there is an advantage in that the ground electrode 500 of the dust collection unit 1000 may extinguish the charges accumulated on the low-voltage side dust collection film, thereby securing the performance of the electric precipitator even for a long time of use.

The present invention is not limited to the above-described embodiments, and it goes without saying that the range of applications is diverse and various modifications are carried out without departing from the gist of the present invention claimed in the claims.

### DESCRIPTION OF REFERENCE NUMERALS

100: first dust collection film
200: second dust collection film
300: first fixing member
301: 1-1 fixing member
302: 1-2 fixing member
303: insertion groove
310: first support
311: 1-1 support
312: 1-2 support
320: first spacer
321: 1-1 spacer
322: 1-2 spacer
331: 1-1 protruding portion
332: 1-2 protruding portion
340: protrusion
350: elastically fixing portion
400: second fixing member
500: ground electrode
510: coupling portion
600: case
610: ground terminal
620: coupling hole
630: coupling protrusion
1000: dust collection unit
2000: charging unit.

1. A dust collection unit for an electric precipitator, comprising:
a plurality of dust collection films arranged to be spaced apart from each other and having different electrodes alternately arranged thereon;
a fixing member coupled to the plurality of dust collection films at one side or both sides at which the plurality of dust collection films are arranged and configured to fix the plurality of dust collection films to be spaced apart from each other at specific intervals; and
a ground electrode stored inside the fixing member.

2. The dust collection unit according to claim 1, wherein the ground electrode is formed to extend in a direction in which the plurality of dust collection films are arranged and coupled to the fixing member to shield an electric field generated by applying a voltage to the plurality of dust collection films.

3. The dust collection unit of claim 1, wherein the plurality of dust collection films include a plurality of first dust collection films connected to a low-voltage side power source and a plurality of second dust collection films connected to a high-voltage side power source, and
the fixing member includes a first fixing member coupled to the plurality of first dust collection films and a second fixing member coupled to the plurality of second dust collection films.

4. The dust collection unit according to claim 3, wherein the ground electrode is coupled to any one or more of the first fixing member and the second fixing member.

5. The dust collection unit according to claim 3, wherein the first fixing member includes a first support formed to extend in a direction in which the plurality of first dust collection films are arranged and a plurality of first spacers formed to protrude from the first support toward the first dust collection film, and
the plurality of first dust collection films are coupled by being inserted between adjacent first spacers.

6. The dust collection unit according to claim 3, wherein the first fixing member includes:
a 1-1 fixing member including a 1-1 support formed to extend in a direction in which the plurality of first dust collection films are arranged and a plurality of 1-1 spacers formed to protrude from the 1-1 support toward the first dust collection film; and
a 1-2 fixing member including a 1-2 support formed to extend in the direction in which the plurality of first dust collection films are arranged and a plurality of 1-2 spacers formed to protrude from the 1-2 support toward the first dust collection film,
an insertion groove is formed in the 1-1 fixing member so that a ground electrode is inserted into the insertion groove, and a portion of the 1-2 fixing member is coupled by being inserted into the insertion groove, and
the 1-1 spacer and the 1-2 spacer are alternately disposed to be spaced apart from each other.

7. The dust collection unit according to claim 6, wherein a plurality of coupling portions are formed to extend to the first dust collection film side, and
the first dust collection film is coupled by being inserted between the plurality of coupling portions.

8. The dust collection unit according to claim 7, wherein the 1-1 fixing member further includes a plurality of 1-1 protruding portions formed to protrude from the 1-1 support toward the first dust collection film, and the 1-2 fixing member further includes a plurality of 1-2 protruding portions formed to protrude from the 1-2 support toward the first dust collection film,
the 1-1 protruding portion is disposed at a position corresponding to the 1-2 spacer, and the 1-2 protruding portion is disposed at a position corresponding to the 1-1 spacer, and
the plurality of coupling portions are interposed between the 1-1 spacer and the 1-2 protruding portion or between the 1-2 spacer and the 1-1 protruding portion.

9. The dust collection unit according to claim 8, wherein portions of the plurality of coupling portions protrude inward from surfaces in which the 1-1 spacer and the 1-2 protruding portion face each other and surfaces in which the 1-2 spacer and the 1-1 protruding portion face each other.

10. The dust collection unit according to claim 5, wherein protrusions are formed to protrude from opposite surfaces into which the first dust collection films are inserted of the plurality of spacers.

11. The dust collection unit according to claim 1, further comprising a case to which the plurality of dust collection films and the fixing member are fixedly coupled.

12. The dust collection unit according to claim 11, wherein a ground terminal is formed on the case, and
one end of the ground electrode is in contact with and electrically connected to the ground terminal.

13. The dust collection unit according to claim 12, wherein the first fixing member includes an elastically fixing portion formed at one side thereof,
the one end of the ground electrode is positioned on the elastically fixing portion of the first fixing member so that the one end of the ground electrode is exposed to or protrudes from an outer surface of the elastically fixing portion, and
a coupling hole and a coupling protrusion are formed on the case so that the elastically fixing portion of the first fixing member is inserted into the coupling hole and a portion of the elastically fixing portion is fixedly caught on the coupling protrusion, and the one end of the ground electrode is in close contact with a ground terminal.

14. An electric precipitator comprising:
the dust collection unit for an electric precipitator according to claim 1; and
a charging unit disposed to be spaced apart from a side adjacent to the ground electrode of the dust collection unit for an electric precipitator and configured to charge passing dust particles.
